(19) United States
(12) Patent Application Publication
(10) Pub. No.: US 2010/0190387 A1
(43) Pub. Date: Jul. 29, 2010

(54) Contact System

(75) Inventors: Georg Busch, Ahaus (DE); Ralf Hünting, Bocholt (DE); Christoph Fels, Coesfeld (DE)

Correspondence Address: FENWICK & WEST LLP, SILICON VALLEY CENTER, 801 CALIFORNIA STREET, MOUNTAIN VIEW, CA, 94041, US

(73) Assignee: Gigaset Communications GmbH, Munich (DE)

(21) Appl. No.: 12/525,243

(22) PCT Filed: Nov. 22, 2007
(86) PCT No.: PCT/EP07/62686

§ 371 Date: Mar. 18, 2010

(30) Foreign Application Priority Data
Jan. 31, 2007 (DE) 10 2007 004 811.6

(51) Int. Cl. H01R 4/48

(52) U.S. Cl. 439/816

(57) ABSTRACT

The invention relates to a contact system comprising a spring and an accordingly associated printed circuit board surface, with which the spring is in contact. The printed circuit board surface to be contacted is a carbon printed circuit board surface. Increased contact resistance between the spring and the carbon printed circuit board surface, which is associated with the contact system according to the invention, is furthermore compensated for by electric and/or electronic means. The spring that is used is provided with a spring force adapted to the carbon printed circuit surface.

The invention relates to a contact system as claimed in the precharacterizing clause of claim 1.

At the moment, in particular, five contact systems are used. In this case, a distinction is drawn between detachable and non-detachable contact systems.

The most cost-effective contact system is based on a tin spring, which makes contact on a tin printed-circuit board surface.

Furthermore, a contact system is known which is based on a gold-plated spring which makes contact on a nickel/gold printed-circuit board surface.

Furthermore, a contact system is known which is formed with a plug and socket and is attached via a cable to, for example, a loudspeaker.

In addition, the document EP 1 708 218 A2 discloses a contact system having at least one contact spring and a switching element which acts on the contact spring, with the contact system having an opposing contact, which is associated with the contact spring, is fitted on a printed circuit board and has a carbon layer.

Finally, a contact system is known which is not detachable, for example based on contact being made by soldering.

Where the following text refers to a gold spring, this means only the end surface of the spring with a gold layer of a thickness of up to 0.1 μm, for example, and not to the entire spring. However, in principle, it is also of course possible to manufacture the gold spring entirely from gold, although this is generally not done, for cost reasons. From the technical point of view, there is also no need to manufacture the spring from solid gold.

The tin-spring on a tin printed-circuit board surface contact system leads to failures in the field as a result of friction corrosion, that is to say to failure of the function of the contact system.

The gold-spring on a gold-circuit board surface contact system is sensitive to dust.

The contact system which has an opposing contact for a spring contact, which opposing contact has a carbon layer, has a lower conductivity than, for example, a gold layer or silver layer.

In the case of switching processes in which only a “digital” switching signal need be evaluated and not for example a signal intensity, the reduced conductivity of the contact system is irrelevant.

A contact system such as this can therefore be used without any problems for example for domestic appliances, in which different switching states must be selected with the aid of a selection switch which has a contact system such as this.

If the three contact systems that have just been mentioned are used in conjunction, for example, with a loudspeaker or else for example a hearing capsule, clicking noises or contact interruptions, or excessively low signal intensities, are possible, because of the disadvantages of these contact systems.

The object of the present invention is to technically improve a contact system such as this, on the basis of a contact system of the type mentioned initially, such that the disadvantages associated with such contact systems, in particular the clicking noises, interruptions and excessively low signal intensities which occur in conjunction with the use of loudspeakers, are avoided. In addition, the improved contact system should cost little.

According to the invention, this object is achieved by a contact system which has the features specified in the characterizing part of claim 1.

The contact system according to the invention, which is based on a spring which makes contact on a printed-circuit board surface, accordingly has a printed-circuit board surface which is a carbon printed-circuit board surface. Furthermore, electrical and/or electronic means are connected to the contact system, this taking account of the contact resistance between the spring and the carbon printed-circuit board surface. Finally, the spring has a contact force which is matched to the carbon printed-circuit board surface.

The use of a carbon printed-circuit board surface for making contact by means of a spring increases the contact resistance from previously typically 20 to 200 μOhm to 2 to 10 Ohm. By way of example, in a hearing capsule connection, the additional resistance is compensated for in an appropriate manner by matching the circuit using appropriate electrical and/or electronic means.

In combination with a spring, whose contact pressure is matched to the relationships in the contact system according to the invention, the contact system according to the invention can be used in the long term.

A further advantage of the contact system according to the invention is that, for example when a keyboard printed circuit board is printed with carbon, it is also possible at the same time to print, for example, hearing capsule contacts, which, on the basis of the previous production system, had to be produced using different materials, in different manufacturing steps. No additional costs are therefore incurred on the printed circuit board, compared for example to a contact system with a tin spring and a tin printed-circuit board surface.

A further advantage is that, provided that no further components require a nickel/gold surface, it may be possible to completely dispense with a nickel/gold surface from making contact.

The lives of the contact system are up to 1 million or more friction cycles, without the robustness of the contact system being lost. In comparison to a previously used contact system with a tin spring and tin printed-circuit board surface, this corresponds to an improvement by a factor >1000.

The contact system according to the invention is also robust with respect to dust during the manufacturing process and in use. While, from experience, all possible metal combinations which have previously been used exhibit clicking noises for a known contact system, in this case once again by way of example in particular with respect to a hearing capsule application, there are no such clicking noises with the contact system according to the invention. The only distinction, as already mentioned above, is a greater contact resistance, which can be compensated for by simple technical measures however, as already likewise mentioned above.

One advantageous refinement of the invention is the subject matter of a dependent claim.

According to this, a gold spring is used as the spring, thus making it possible to achieve the best-possible quality in the contact behavior of the contact system.

The use of the contact system in conjunction with the fitting of a hearing capsule to a corresponding associated printed circuit board is mentioned once again as an exemplary embodiment, in which case now, in particular the hearing capsule is provided with gold springs which operate with an increased contact pressure and, when the hearing capsule is mounted on the printed circuit board, press on correspondingly associated printed-circuit board surfaces, in this case now composed of carbon, and make contact in this way.

What is claimed is:

1. A contact system, having a spring which makes contact with a carbon printed-circuit board surface, characterized in that electrical and/or electronic means are connected to the contact system, by means of which a higher contact resistance, which results from the use of the carbon printed-circuit board surface for making contact with the spring, between the spring and the carbon printed-circuit board surface is compensated for, and in that the spring has an increased spring force acting on the carbon printed-circuit board surface.

2. The contact system as claimed in claim 1, characterized in that the spring is a gold spring or a gold-coated spring.
